(19) United States
(12) Patent Application Publication
(10) Pub. No.: US 2017/0137078 A1
(43) Pub. Date: May 18, 2017

(54) ROBOTIC VEHICLE

(71) Applicant: HON HAI PRECISION INDUSTRY CO., LTD., New Taipei (TW)

(72) Inventor: CHIEN-YUAN TSENG, New Taipei (TW)

(21) Appl. No.: 15/343,445

(22) Filed: Nov. 4, 2016

Related U.S. Application Data
(60) Provisional application No. 62/256,720, filed on Nov. 18, 2015.

(51) Int. Cl. B62D 55/075; B62D 55/30; B62D 55/065

(52) U.S. Cl. CPC B62D 55/075; B62D 55/065; B62D 55/305; B60Y 2200/47; B60Y 2200/80

(57) ABSTRACT

A robotic vehicle includes a chassis, a cabin, a driving device, a plurality of detection devices, and a control device. The cabin is installed in the upper portion of the chassis. The driving device is positioned on the chassis for moving the robotic vehicle and rotating the cabin. A plurality of detection devices and a control device are installed for reconnoitering an area. The two sides of the chassis are coupled to track wheels, and a front portion of the chassis is coupled to a climbing support mechanism.

### FIELD

The subject matter herein generally relates to robotic vehicle, and, in particular, to a robot vehicle which can assist in investigation and detection of vehicles.

### BACKGROUND

When a natural disaster occurs, the complexity and density of urban environment adds to the probability of posing deadly threats in areas that cannot be easily reconnoitered. So it is important to send a remote forward-piloted apparatus ahead of the investigation, search or rescue team. Without understanding the conditions of the disaster site, it can be dangerous for a person to explore. Being aware of all situations is a necessary requirement to optimize safety in field operations. What is needed is a robotic vehicle that is able to arrive at a target area, reconnoiter an area, travel over rugged terrain, gas detection, put out fires or perform other tasks.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a perspective view of a robotic vehicle according to an exemplary embodiment.

FIG. 2 illustrates an exploded perspective view of the robotic vehicle shown in FIG. 1.

FIG. 3 illustrates a perspective view of a chassis of the robotic vehicle shown in FIG. 1.

FIG. 4 illustrates a bottom view of the chassis of the robotic vehicle shown in FIG. 3.

FIG. 5 illustrates a side view of track wheels shown in FIG. 4.

FIG. 6 illustrates a perspective view of another exemplary embodiment of the track wheels shown in FIG. 4.

FIG. 7 illustrates a perspective view of another exemplary embodiment of the robotic vehicle shown in FIG. 1.

FIG. 8 illustrates a side view of a climbing support mechanism shown in FIG. 1.

FIG. 9 illustrates a top view of the climbing support mechanism shown in FIG. 6.

FIG. 10 illustrates a bottom view of a rotation mechanism shown in FIG. 1.

FIG. 11 illustrates a side view of a lifting mechanism shown in FIG. 1.

FIG. 12 illustrates a perspective view of a gas detection device shown in FIG. 1.

FIG. 13 illustrates a front view of the gas detection device shown in FIG. 10.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

Several definitions substantially that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a robotic vehicle.

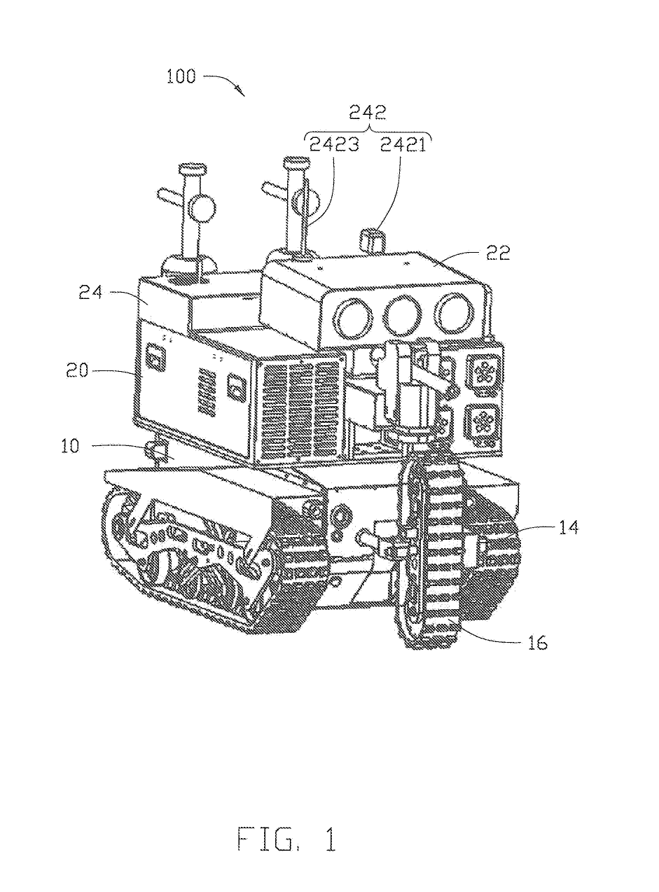

FIG. 1 illustrates an exemplary embodiment of a robotic vehicle 100 for reconnoitering. The robotic vehicle 100 is designed for arriving at a target area, reconnoiters the target area, and is configured to travel over rugged terrain, climb stairs, and carry necessary equipment loads.

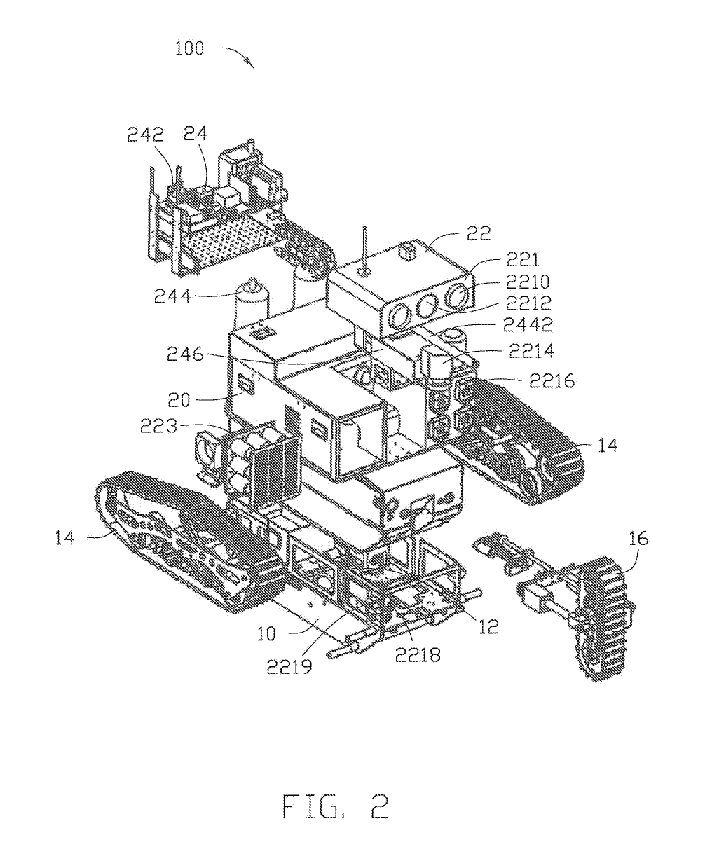

The robotic vehicle 100 includes a chassis 10 and a cabin 20 installed on the upper portion of the chassis 10. The chassis 10 is configured to position a driving device 12 (shown in FIG. 2) for moving the robotic vehicle 100 and rotation of the cabin 20. The cabin 20 is configured to position a plurality of detection devices 22 and a control device 24 for reconnoitering an area and conduct fire fighting work. A power source (not shown) is installed in the chassis 10 and the cabin 20 respectively, for example a battery power pack.

FIG. 2 illustrates two sides of the chassis 10 respectively coupled to two track wheels 14, and a front portion of the chassis 10 is coupled to a climbing support mechanism 16. The detection devices 22 and the control device 24 are installed on the upper portion of the cabin 20. The detection devices 22 include an image sensing device 221 and a gas detection device 223. The control device 24 includes a communication device 242, a fire extinguisher 244, and a lifting mechanism 246. In the illustrated exemplary embodiment, the image sensing device 221 includes an infrared imaging device 2210, a thermal imaging device 2212, a laser device 2214, a lighting device 2216, two cameras 2218, and two radar detectors 2219. The infrared imaging device 2210 and the thermal imaging device 2212 are at the forefront portion of image sensing device 221. The laser device 2214 is at a forefront position of the cabin 20, and the lighting device 2216 and the gas detection device 223 are located on two sides of the laser device 2214. The control device 24 and the fire extinguisher 244 are at rear position of the cabin 20 with a nozzle 2442 of the fire extinguisher 244 protruding from the forefront of the robotic vehicle 100. The communication device 242 includes a global positioning system (GPS) 2421 and an antenna 2423 (shown in FIG. 1) at a top position of the cabin 20. The two cameras 2218 are respectively located in the front end and the rear end of the chassis 10. The two radar detectors 2219 are also respectively located in the front end and the rear end of the chassis 10.

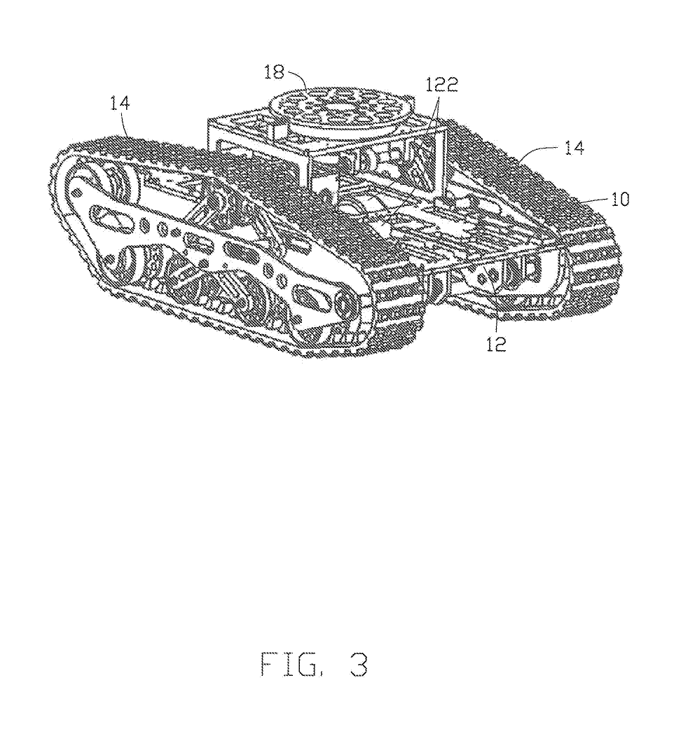

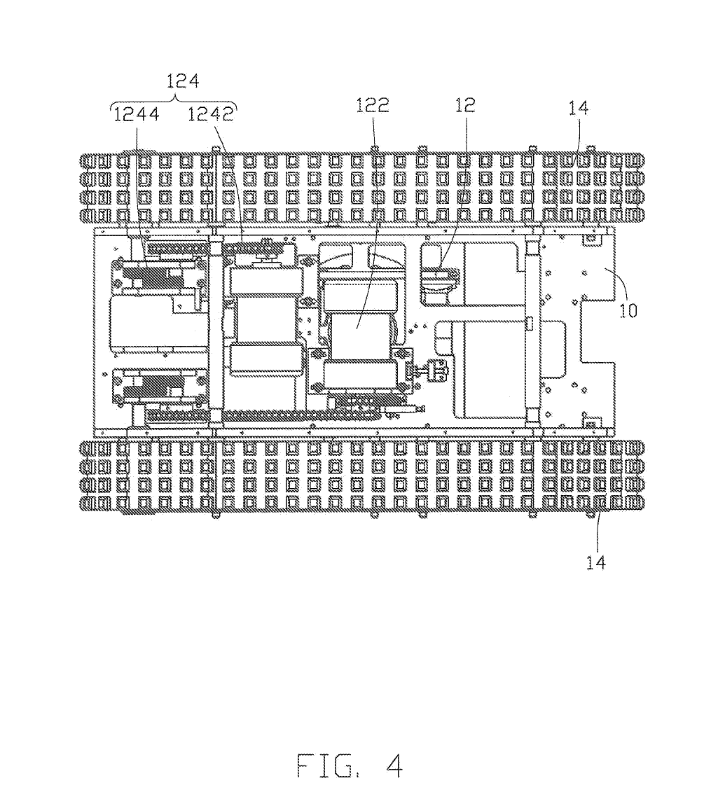

FIG. 3 illustrates an exemplary embodiment of the chassis 10, the driving device 12 is installed inside of the chassis 10 and a rotation mechanism 18 is located at top portion of the chassis 10. The driving device 12 includes two drive motors 122 configured to move the track wheels 14. The rotation mechanism 18 is rotatably coupled to the cabin 20 (shown in FIG. 2). FIG. 4 illustrates a transmission mechanism 124 that is configured to transfer power to the drive motor 122 for moving the track wheels 14. In the illustrated exemplary embodiment, the transmission mechanism 124 is a chain wheel 1242 and a gear mechanism 1244.

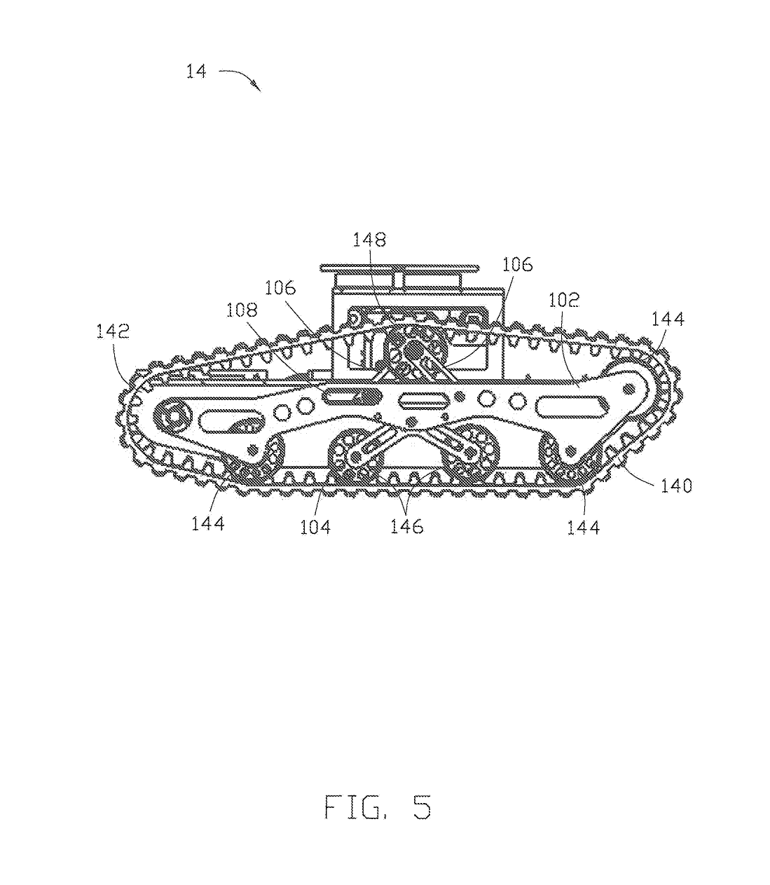

FIG. 5 illustrates an exemplary embodiment of the track wheels 14. The track wheels 14 includes an endless track 140, a power wheel 142, a plurality of leading idler wheels 144, two trailing idler wheels 146, and a tension wheel 148.

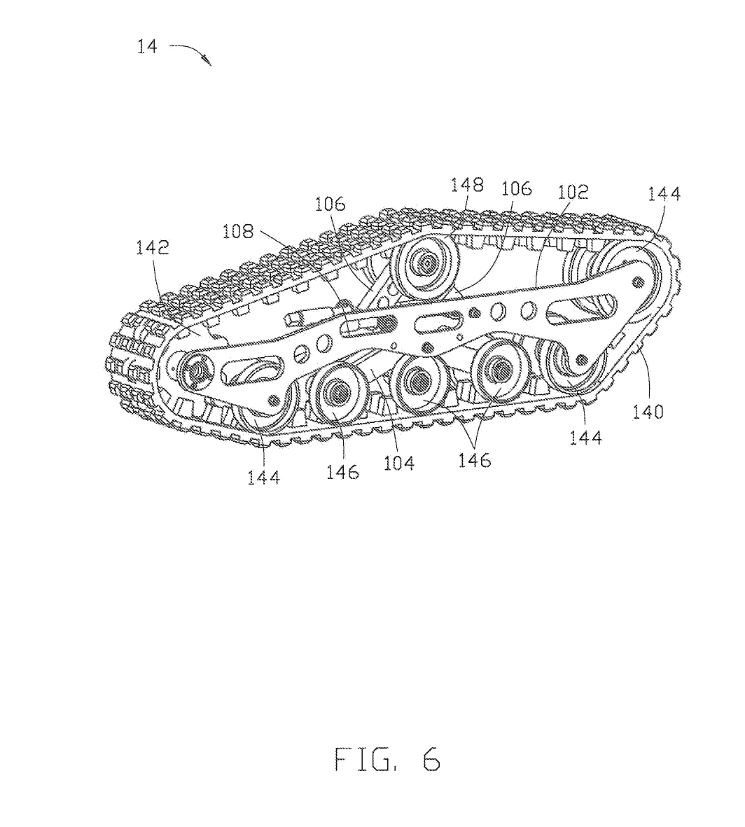

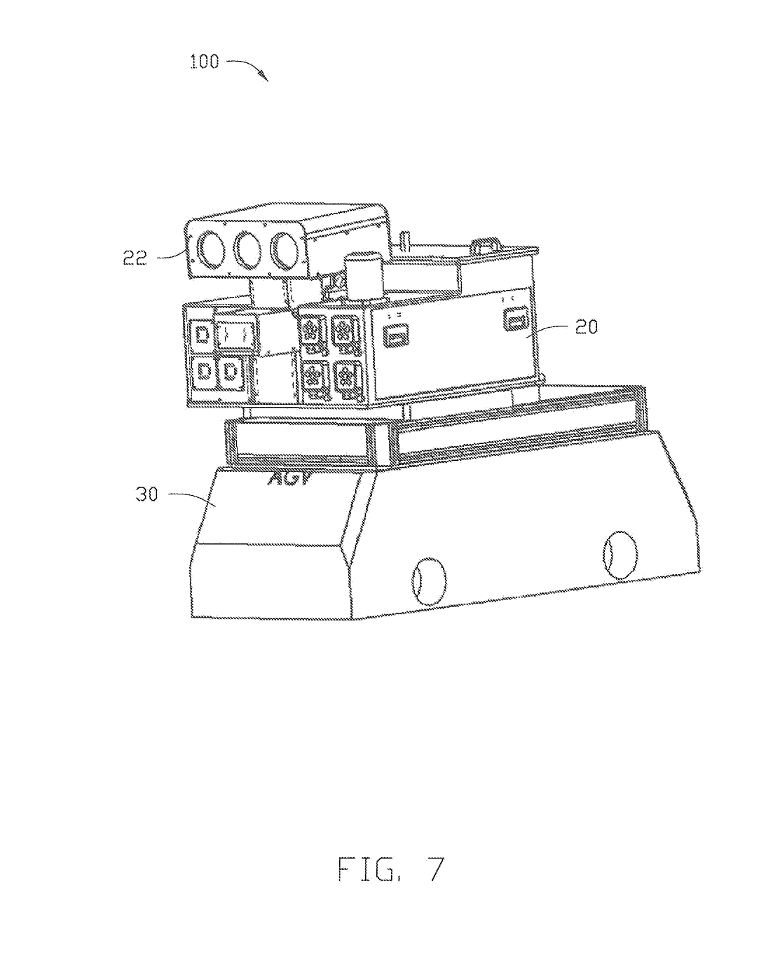

The endless track 140 is positioned to surround the power wheels 142, the leading idler wheels 144, the trailing idler wheels 146, and the tension wheel 148. The power wheel 142 is coupled to the transmission mechanism 124 for transmission power of the drive motor 122 (shown in FIG. 4) and is located at one end of a supporting frame 102 of the chassis 10. The other end of the supporting frame 102 is coupled to one of the leading idler wheels 144. The leading idler wheels 144 are coupled to the bottom portion of the supporting frame 102 close to the power wheel 142. One of the leading idler wheels 144 is mounted at one end of a supporting frame 102, and another leading idler wheels 144 is mounted at another end of a supporting frame 102. The two trailing idler wheels 146 are mounted on bottom center portion of the supporting frame 102 by a free swinging crank 104. According to different terrain data, the two trailing idler wheels 146 with the free swinging crank 104 are configured to contact ground side of the track wheels 14. The tension wheel 148 is located on upper center portion of the supporting frame 102 connected to two shafts 106. One of the shafts 106 is pivoted on the supporting frame 102, and the other shaft 106 is pivoted in a chute 108 of the supporting frame 102. Therefore, the shafts 106 are configured to slide in the chute 108 to adjust the height of the tension wheel 148. The tension wheel 148 generates tension on the endless track 140 of the track wheels 14. For stable operation of the robotic vehicle 100, a plurality of the trailing idler wheels 146 are installed with the free swinging crank 104 (shown in FIG. 6), or mount the cabin 20 on an automated guided vehicle (AGV) 30 (shown in FIG. 7).

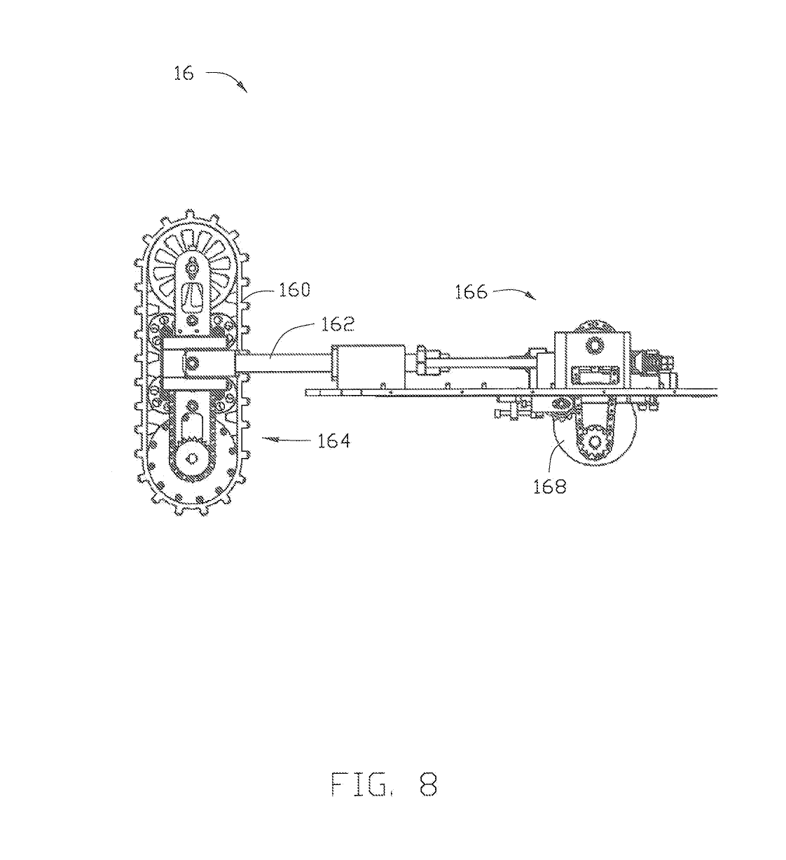

FIG. 8 illustrates an exemplary embodiment of the climbing support mechanism 16. The climbing support mechanism 16 includes a first transmission mechanism 164, a second transmission mechanism 166 and a drive motor 168. The first transmission 164 comprises a track wheel 160 and a framework 162.

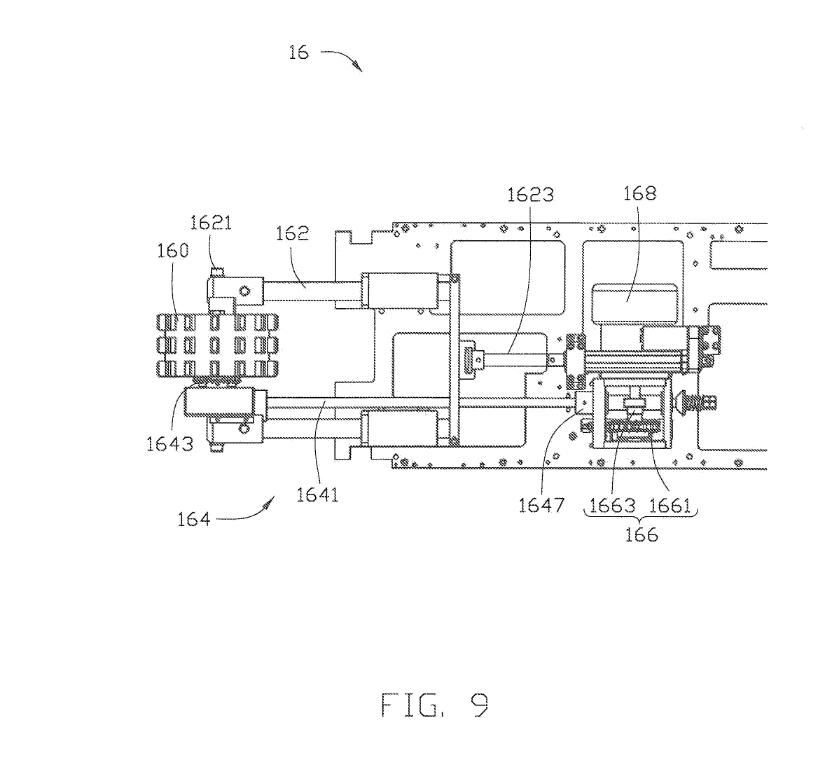

The opening end of the framework 162 includes an axle 1621 as shown in FIG. 9. The closing end of the framework 162 is coupled to a cylinder push rod 1623. The track wheel 160 is coupled to the axle 1621 and is configured for free swing. The first transmission mechanism 164 further comprises a guide bar 1641 and a chain wheel 1643. A bevel gear 1645 is installed between the guide bar 1641 and the chain wheel 1643. The bevel gear 1645 is coupled to the guide bar 1641. The chain wheel 1643 is configured to transfer rotation of the guide bar 1641 to drive the chain wheel 1643 and rotates the track wheels 160. The guide bar 1641 is coupled to the framework 162 for moving synchronously. The second transmission mechanism 166 comprises a chain wheel 1661 and a bevel 1663. The chain wheel 1661 is coupled to the drive motor 168 and is configured to transfer rotation power of the drive motor 168 to the bevel 1663. A bevel 1647 is provided on the end of the guide bar 1641 of the first transmission mechanism 164 close to the bevel 1663 of the second transmission mechanism 166. When the guide bar 1641 moves forward, the bevel 1647 and the bevel 1663 engage together so that the rotation power of the drive motor 168 can drive the guide bar 1641 through the engagement of the bevel 1647 and the bevel 1663. When the guide bar 1641 moves backward with the framework 162, the bevel 1647 and the bevel 1663 separate from each other like a clutch to stop the rotation of the guide bar 1641. The framework 162 also moves with the guide bar 1641.

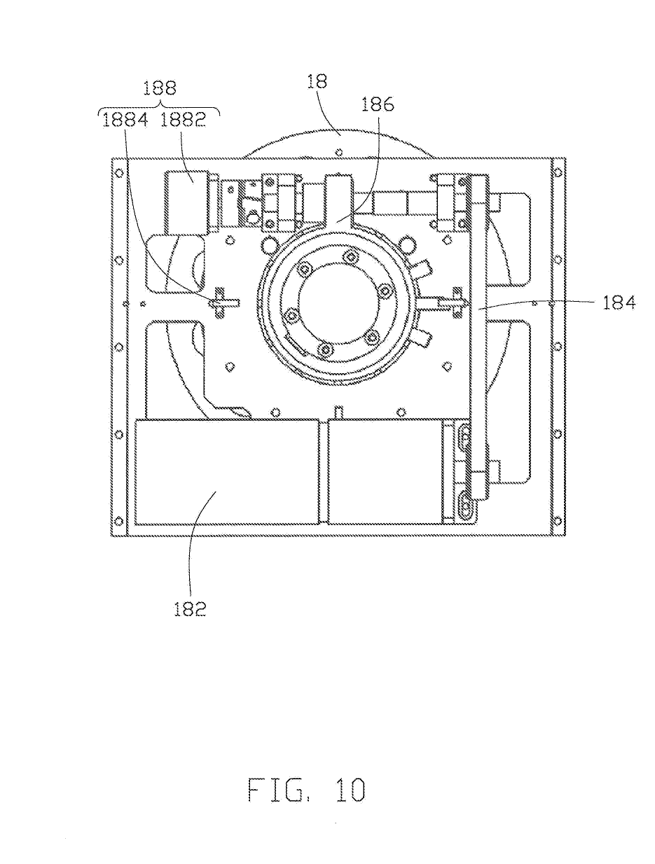

FIG. 10 illustrates a bottom view of the rotation mechanism 18, which includes a drive motor with retarder 182, a synchronous pulley 184, a bevel gear 186 and a location device 188. The drive motor with retarder 182 is coupled to the synchronous pulley 184, and the synchronous pulley 184 is coupled to the bevel gear 186. The drive motor with retarder 182 is configured to drive the rotation mechanism 18 to rotate through the bevel gear 186. In the illustrated exemplary embodiment, the angle of rotation of the rotation mechanism 18 is up to 180 degrees. An axis 1862 of the bevel gear 186 is coupled to a rotary encoder 1882 of the location device 188. A groove photoelectric 1884 of the location device 188 is configured to detect the rotation condition of the bevel gear 186 so that the location device 188 can effectively control the rotation position of the rotation mechanism 18.

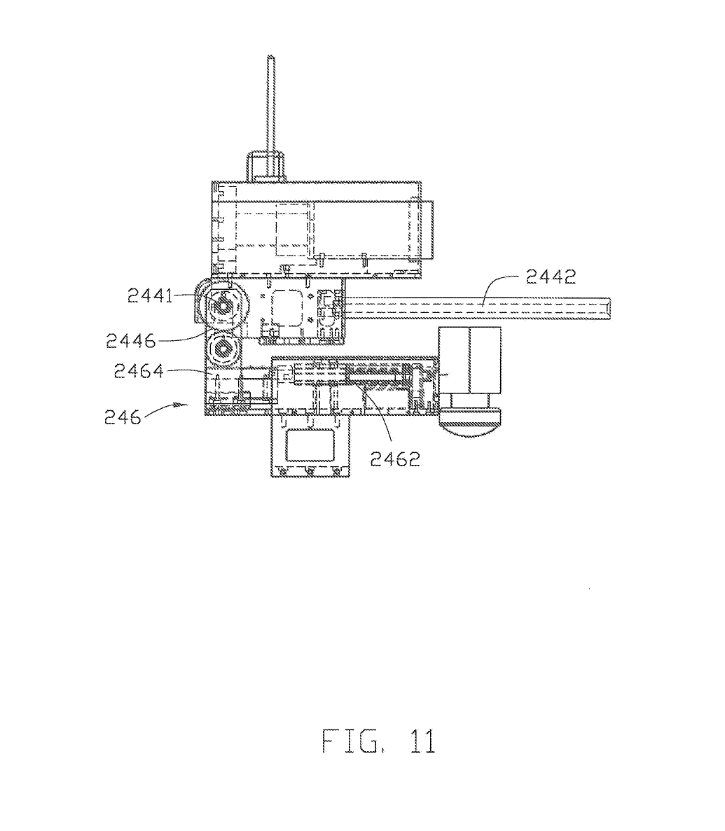

FIG. 11 illustrates an exemplary embodiment of the lifting mechanism 246 of the control device 24. The lifting mechanism 246 is installed in the cabin 20 and is coupled to the nozzle 2442 of the fire extinguisher 244. The lifting mechanism 246 includes a cylinder push rod 2462, a rack 2464, and a gear set 2466. The cylinder push rod 2462 is coupled to the rack 2464 and is configured to drive linear displacement. The gear set 2466 includes two gears engaged together, one gear of the gear set 2466 is coupled to an axle 2441 of the nozzle 2442 holder, and the other gear of the gear set 2466 is coupled to the rack 2464. The cylinder push rod 2462 is configured to drive the rack 2464 to move linearly. The gear set 2466 of the rack 2464 is configured to lift the nozzle 2442. In the exemplary embodiment, the lifting angle of the lifting mechanism 246 is substantially around 5 degrees to 60 degrees.

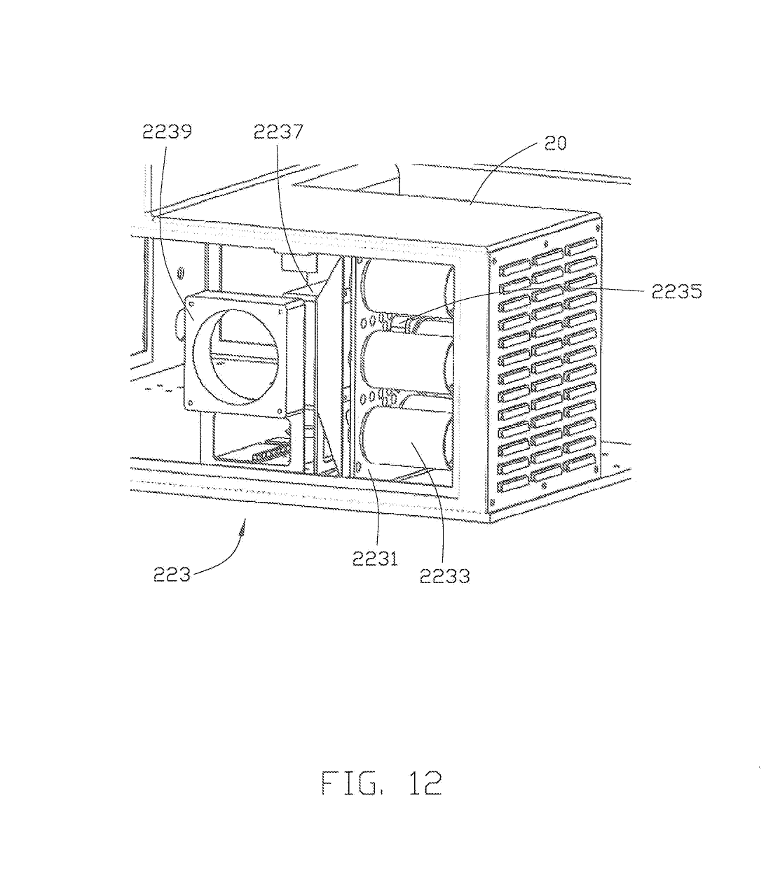

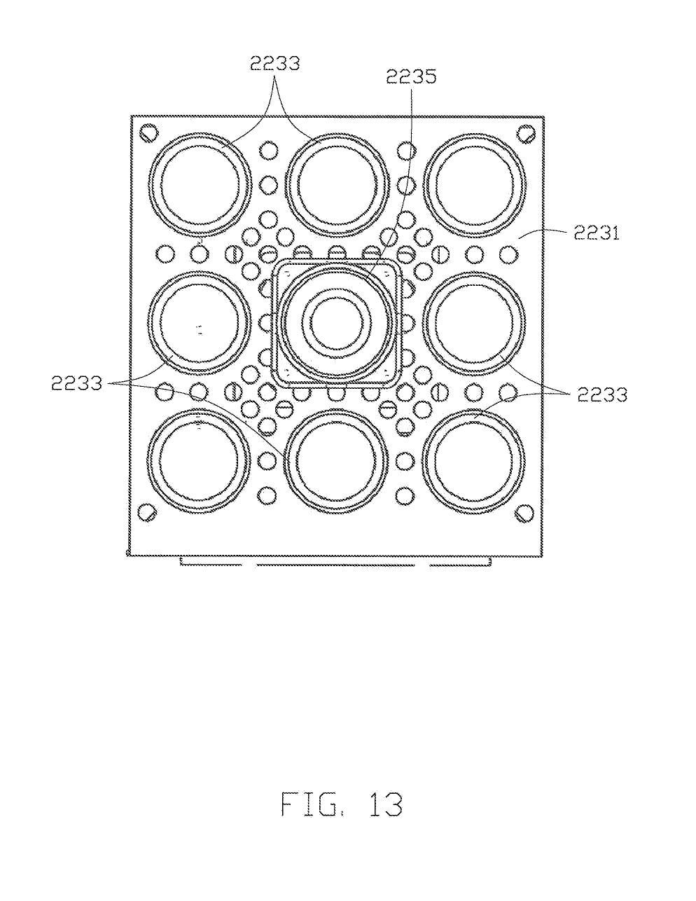

FIG. 12 illustrates an exemplary embodiment of the gas detection device 223 is located in front portion of the one side of the cabin 20. The gas detection device 223 includes a base plate 2231, a plurality of gas detectors 2233, a warning device 2235, a suction device 2237, and an exhaust 2239. The base plate 2231 is defined as square shape, the plurality of gas detectors 2233 and the warning device 2235 are provided on the base plate 2231. The suction device 2237 is located in the rear portion of the base plate 2231, and the exhaust 2239 is provided on one side of the suction device 2237. The suction device 2237 draws gases from the front of the cabin 20. The gases pass through the plurality of gas detectors 2233 for gas detection, and the gases are exhausted through the exhaust 2239 at the lateral side of the cabin 20. In the illustrated exemplary embodiment, the number of gas detectors 2233 is eight. The warning device 2235 is provided in the middle portion of the base plate 2231 (shown in FIG. 13).

It is believed that the discussed exemplary embodiments and their advantages will be understood from the foregoing description, and it will be apparent that various changes may be made thereto without departing from the disclosure or sacrificing all of its material advantages. The exemplary embodiments discussed herein do not limit the following claim.

What is claimed is:

1. A robotic vehicle comprising:
a chassis;
a cabin installed in the upper portion of the chassis;
a driving device positioned on the chassis for moving the robotic vehicle and rotating the cabin; and
a plurality of detection devices, the detective devices and a control device are installed on the upper portion the cabin for reconnoitering an area,
wherein two sides of the chassis are respectively coupled to two track wheels, and a front portion of the chassis is coupled to a climbing support mechanism.

2. The robotic vehicle of claim 1, wherein the detection devices comprises an image sensing device and a gas detection device.

3. The robotic vehicle of claim 2, wherein the image sensing device comprises an infrared imaging device, a thermal imaging device, a laser device, a lighting device, two cameras, and two radar detectors.

4. The robotic vehicle of claim 3, wherein the infrared imaging device and the thermal imaging device are at the forefront portion of image sensing device.

5. The robotic vehicle of claim 3, wherein the laser device is at a forefront position of the cabin.

6. The robotic vehicle of claim 3, wherein the gas detection device is located on two sides of the laser device.

7. The robotic vehicle of claim 3, wherein the two cameras are respectively located in the front end and the rear end of the chassis.

8. The robotic vehicle of claim 3, wherein the two radar detectors are respectively located in the front end and the rear end of the chassis.

9. The robotic vehicle of claim 1, wherein the control device comprises a communication device, a fire extinguisher, and a lifting mechanism.

10. The robotic vehicle of claim 8, wherein the fire extinguisher is at a rear position of the cabin, and a nozzle of the fire extinguisher protrudes from the front side of the robotic vehicle.

11. The robotic vehicle of claim 1, wherein the robotic vehicle further comprises a power source installed in the chassis and the cabin.

12. A track wheel for a robotic vehicle comprising:
an endless track surrounding a plurality of wheels, wherein the wheels comprise:
a power wheel located at one end of a supporting frame for transmission power;
a plurality of leading idler wheels respectively coupled to the bottom portion of the supporting frame close to the power wheel, wherein at least one of the leading idler wheels is mounted at one end of a supporting frame;
a plurality of trailing idler wheels mounted on bottom center portion of the supporting frame by a free swinging crank; and
a tension wheel located on upper center of the supporting frame connected to two shafts,
wherein the trailing idler wheels with the free swinging crank are configured to contact a ground side of the track wheels, one of the shafts is pivoted on the supporting frame, the other shaft is pivoted in a chute of the supporting frame, and the shafts are configured to slide in the chute to adjust the height of the tension wheel, and the tension wheel generates tension on the endless track of the track wheels.

13. A climbing support mechanism for a robotic vehicle comprising:
a first transmission mechanism comprising a track wheel, a bevel gear, a guide bar, and a first chain wheel;
a second transmission mechanism coupled to the first transmission mechanism by a framework, wherein the second transmission mechanism comprises a bevel and a second chain wheel; and
a drive motor coupled to the second transmission;
wherein the second chain wheel is coupled to the drive motor and configured to transfer rotation power of the drive motor to the bevel, the bevel gear is installed between the guide bar and the first chain wheel and configured to transfer the rotation power of the guide bar from the bevel to the first chain wheel, and the rotation power drives the track wheel.

14. The climbing support mechanism of claim 13, wherein the guide bar is coupled to the framework for moving synchronously.

15. The climbing support mechanism of claim 13, wherein the opening end of the framework comprising an axle, and the track wheel is coupled to the axle for free swing.

16. The climbing support mechanism of claim 13, wherein the closing end of the framework is coupled to a cylinder push rod, and the cylinder push rod is configured to push the guide bar forward and pull the guide bar backward.

17. The climbing support mechanism of claim 13, wherein the second transmission mechanism further comprises a second bevel coupled to the second chain wheel, when the guide bar moves, the bevel and the second bevel are engaged.
